(19) United States
(12) Patent Application Publication
(10) Pub. No.: US 2025/0240102 A1
(43) Pub. Date: Jul. 24, 2025

(54) SINGLE PHOTON EMITTERS BASED ON NANORIBBONS

(71) Applicants: HONDA MOTOR CO., LTD., Tokyo (JP); Columbia University, New York, NY (US)

(72) Inventors: Xufan Li, Fremont, CA (US); Avetik R. Harutyunyan, Stoneham, MA (US); Peter James Schuck, New York, NY (US); James Curtis Hone, New York, NY (US)

(21) Appl. No.: 19/036,782

(22) Filed: Jan. 24, 2025

Related U.S. Application Data
(60) Provisional application No. 63/624,478, filed on Jan. 24, 2024.

(51) Int. Cl. B82Y 20/00; B82Y 40/00

(52) U.S. Cl. CPC H04B 10/70; B82Y 20/00; B82Y 40/00

(57) ABSTRACT

This disclosure provides systems, methods and apparatuses for single photon emitters based on nanoribbons. A single photon emitter includes: a substrate; at least one nanostructure disposed on the substrate; and a nanoribbon disposed over at least one apex of the at least one nanostructure. The nanoribbon may include a transition metal dichalcogenide (TMD). A method of manufacturing a single photon emitter includes: growing a transition metal dichalcogenide (TMD) nanoribbon on a first substrate; collecting the TMD nanoribbon on a polymer film; stacking the TMD nanoribbon and polymer film on a second substrate having nanostructures with the TMD nanoribbon disposed over an apex of the at least one nanostructure; and removing the polymer film.

### CROSS-REFERENCE TO RELATED APPLICATIONS

This application claims priority to U.S. Provisional Application No. 63/624,478 titled “SINGLE PHOTON EMITTERS BASED ON NANORIBBONS,” filed Jan. 24, 2024, which is assigned to the assignee hereof, and incorporated herein by reference in its entirety.

### BACKGROUND

Quantum communication is a key to future information technologies such as quantum internet that enables ultra-secure communications. One component for quantum communication is the quantum bit (qubit) that stores and transmits information encoded in inherently quantum mechanical systems. A single photon is an ideal qubit for quantum communication due to its fast transmission, low-noise, improved information protection, and long coherence time. However, there lacks an ideal single photon emitter (SPE) that can provide on-demand, high purity, indistinguishable single photons with deterministic positioning. One conventional SPE uses laser-based heralded single photons generated via spontaneous parametric down conversion. The disadvantage of this conventional SPE is that the photon generation timing is probabilistic, which means that the photons are not “on demand” and not always in single pairs. Atomically thin two-dimension (2D) materials have emerged as a potential type of SPEs due to their high efficiency in light extraction, facile integration with existing photonics, tunable optical properties, high single-photon purity and brightness, and electrical addressability. A single layer of transition metal dichalcogenides (TMDs) such as tungsten diselenide (WSe₂) and atomically-thin layers of hexagonal boron nitride (hBN) have demonstrated single photon emission at temperatures ranging from 4 K to 295 K, from highly localized energy states created at strains like wrinkle, folding, bubbling, or point-like strain by nanopillars, or implanted defects. However, such SPEs are not deterministic as the above-mentioned strains in 2D films are generally inhomogeneous, and the implanted defects are also not site-controllable and involved with many unknown origins. Therefore, improvements in single phone emitters may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Certain aspects of the present disclosure includes a single photon emitter, comprising a substrate, at least one nanostructure disposed on the substrate, and a nanoribbon disposed over at least one apex of the at least one nanostructure.

In some aspects, the techniques described herein relate to a single photon emitter, wherein the nanoribbon includes a transition metal dichalcogenide (TMD).

In some aspects, the techniques described herein relate to a single photon emitter, wherein the TMD is one of: MoS2, MoSe2, WS2, or WSe2.

In some aspects, the techniques described herein relate to a single photon emitter, wherein the nanoribbon has a width between 7 and 50 nm.

In some aspects, the techniques described herein relate to a single photon emitter, wherein the nanoribbon has width between 7 and 20 nm.

In some aspects, the techniques described herein relate to a single photon emitter, wherein the at least one nanostructure includes one or more of a nanocone, a nanopillar, a nano-pyramid, or a nano-ridge.

In some aspects, the techniques described herein relate to a single photon emitter, wherein a tip size of the nanostructure is between 20 and 50 nanometers.

In some aspects, the techniques described herein relate to a single photon emitter, wherein the nanoribbon is a single layer.

In some aspects, the techniques described herein relate to a single photon emitter, wherein the substrate is silicon dioxide and the nanostructure is gold.

In some aspects, the techniques described herein relate to a single photon emitter, wherein a single photon purity of an emission is between 95 percent and 98 percent as measured by g2(τ).

In some aspects, the techniques described herein relate to a single photon emitter, wherein the single photon purity is between 95 percent and 98 percent when operating at a temperature between 90 Kelvin and 120 Kelvin.

In some aspects, the techniques described herein relate to a single photon emitter, further including an excitation laser configured to emit at beam toward the nanoribbon disposed over at least one apex of the at least one nanostructure.

In some aspects, the techniques described herein relate to a single photon emitter, wherein the excitation laser has an excitation wavelength of about 532 nm and a power between 60 nW and 20 μW.

In some aspects, the techniques described herein relate to a single photon emitter, further including a cryostat configured to cool the substrate and the nanoribbon to a temperature less than 120 Kelvin.

In some aspects, the techniques described herein relate to a method, including: growing a transition metal dichalcogenide (TMD) nanoribbon on a first substrate; collecting the TMD nanoribbon on a polymer film; stacking the TMD nanoribbon and polymer film on a second substrate having nanostructures with the TMD nanoribbon disposed over an apex of the at least one nanostructure; and removing the polymer film.

In some aspects, the techniques described herein relate to a method, wherein growing the TMD nanoribbon includes: heating a first precursor powder including a metal oxide powder, a metal powder, and a salt powder and passing a moisturized inert gas flow by the first precursor powder to deposit seed nanoparticles on the first substrate; and heating a second precursor powder including a chalcogen upstream from the first substrate to produce a chalcogen vapor; and passing an inert gas flow from a location of the second precursor powder by the first substrate.

In some aspects, the techniques described herein relate to a method, wherein collecting the TMD nanoribbon on the polymer film includes: pressing the polymer film against the TMD nanoribbon on the first substrate; and floating the first substrate, TMD nanoribbon, and polymer film in deionized water.

In some aspects, the techniques described herein relate to a method, wherein stacking the TMD nanoribbon and polymer film on the second substrate includes aligning the TMD nanoribbon with the apex of the at least one nanostructure under an optical microscope.

In some aspects, the techniques described herein relate to a method, wherein removing the polymer film includes heating the stacked polymer film, the TMD nanoribbon, and the second substrate.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1A illustrates an example of a substrate having a nanoribbon according to aspects of the present disclosure.

FIG. 1B illustrates an example of a single photon emitter according to aspects of the present disclosure.

FIG. 2A illustrates an example of a schematic showing a substrate having a plurality of nanocones and a nanoribbon according to aspects of the present disclosure.

FIG. 2B illustrates an example of an atomic-force microscopy (AFM) image of the gold (Au) nanocones on a silicon dioxide (SiO₂) substrate on which the single layer (SL) TMD nanoribbons will be placed according to aspects of the present disclosure.

FIG. 2C illustrates an example of a scanning electron microscopy (SEM) image showing a SL MoS2 nanoribbon lying on the substrate with Au nanocones according to aspects of the present disclosure.

FIG. 3 illustrates an example process of placing nanoribbons on the nanostructures according to aspects of the present disclosure.

FIG. 4A illustrates an example of an emission spectrum from the spot where the SL MoS2 nanoribbon lies across the apex of the nanocone as indicated in FIG. 2C according to aspects of the present disclosure.

FIG. 4B illustrates an example of an emission intensity and energy mapping of consecutive spectral scans according to aspects of the present disclosure.

FIG. 5A illustrates an example of an AFM topography showing a strained SL WSe₂ nanoribbon on Au nanocones according to aspects of the present disclosure.

FIG. 5B illustrates a mapping of integrated emission intensity from the strained SL WSe₂ nanoribbon 510 when excited by a 532 nm laser at 4 K according to aspects of the present disclosure.

FIG. 5C illustrates a emission spectrum from one of the regions of the SL WSe₂ nanoribbon strained by a nanocone according to aspects of the present disclosure.

FIG. 5D illustrates a chart of g²(τ) photon anti-bunching measurement on the quantum emission at ˜1.64 eV in FIG. 5C according to aspects of the present disclosure.

FIG. 6A is an image from an optical microscope showing an example of strained SL WSe₂ nanoribbons on Au nano-pyramids according to aspects of the present disclosure.

FIG. 6B is an AFM topography showing the region indicated by the dashed circle in FIG. 6A.

FIG. 6C is a chart of temperature-dependent emission spectra from the region of the SL WSe₂ nanoribbon strained by the nano-pyramid 620 in FIG. 6B according to aspects of the present disclosure.

FIG. 6D is a chart of a g²(τ) factor photon anti-bunching measurement on QE1 and QE2 from temperature 4 K to 120 K according to aspects of the present disclosure.

FIG. 7 s a flowchart of an example method for manufacturing a single photon emitter.

### DETAILED DESCRIPTION

Some aspects of the present disclosure include a new scheme for achieving on demand, high-purity, and deterministic positioning single phone emission via a single photon emitter (SPE) from single layer (SL) nanoribbons of transition metal dichalcogenides (TMDs). The SL TMD nanoribbons with width down to sub-10 nm may be synthesized using methods disclosed in U.S. Pat. Nos. 11,408,073 and/or 11,639,546, the disclosures of which are hereby incorporated by reference in their entireties. The materials for the SL TMD nanoribbons may include MoS₂, MoSe₂, WS₂, WSe₂ or other suitable materials. The SL TMD nanoribbons may be picked up from the growth substrate and placed on another substrate having nanostructures such as nanocones, nanopillars, nano-pyramids, and/or nano-ridges. An example of the tip size of the nanostructures may be 20-50 nanometers. Other sizes may also be implemented according to aspects of the present disclosure. Sharp bending may be created in the nanoribbon laying on the apex of the nanostructure, and unlike 2D films, the quasi-one-dimensional nanoribbon with confinement on width (<20 nm) may generate a point-like strain that gives deterministic positioning of the highly localized state responsible for single photon emission. Aspects of the present disclosure include implementing a scheme for generating clean, sharp quantum emission from SL TMD nanoribbons laying across the apex of the nanostructures. Such a platform may be refined to realize an SPE that meets the requirements as light source for quantum communication.

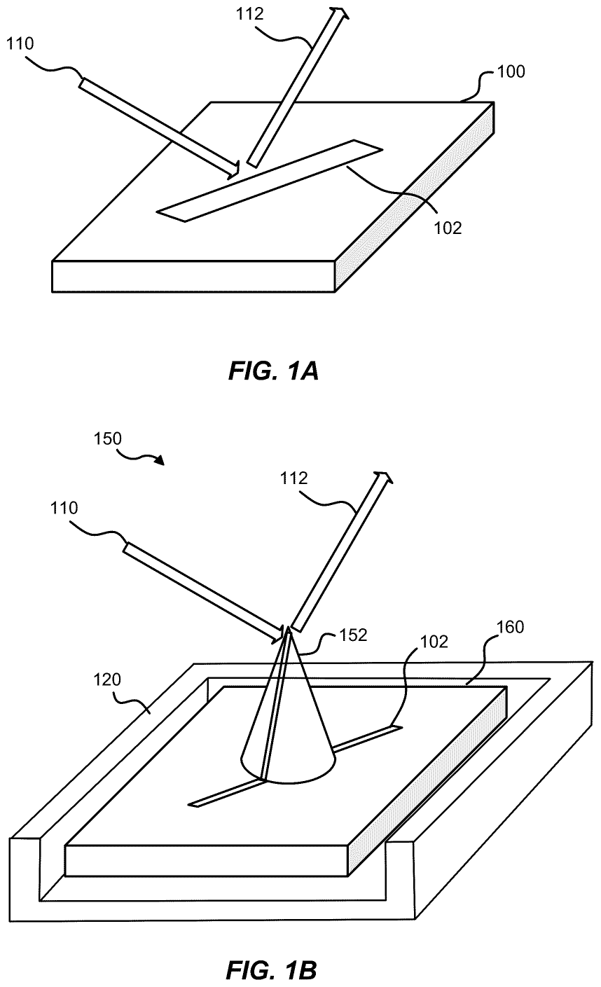

FIG. 1A illustrates an example of a substrate having a nanoribbon according to aspects of the present disclosure. A nanoribbon 102 may be deposited on a substrate 100 using a variety of methods. In some aspects, the method may include subjecting two or more precursor powders to conditions sufficient to deposit a TMD material onto a substrate. The two or more precursor powders may comprise a metal oxide powder and a chalcogen powder. It should be understood that the metal oxide powder and the chalcogen powder may be selected in order to provide a certain TMD material. For example, the metal oxide powder may comprise molybdenum dioxide (MoO₂) and the chalcogen powder may comprise sulfur(S) to provide a TMD material comprising molybdenum disulfide (MoS₂). Additionally or alternatively, tungsten dioxide (WO₂) and/or tungsten trioxide (WO₃) may be used as a metal oxide powder and/or selenium (Se) may be used as a chalcogen powder such that the TMD material may comprise tungsten disulfide (WS₂) and/or molybdenum diselenide (MoSe₂) and/or tungsten diselenide (WSe₂). According to some aspects, the two or more precursor powders may additionally comprise a salt powder. As used herein, the term “salt” refers to an electrically neutral ionic compound having cation(s) and anion(s). Examples of salts usefulness according to the present disclosure include, but are not limited to, sodium salts and potassium salts, such as NaBr, NaCl, KBr, KCl, and combinations thereof. According to some aspects, the two or more precursor powders may comprise a metal powder. The metal powder may comprise a metal that is the same as the metal comprised by the metal oxide powder or different from the metal comprised by the metal oxide powder. According to some aspects, the metal powder may comprise a transition metal such as nickel (Ni), iron (Fe), or a combination thereof.

In some implementations, the nanoribbon 102 may be grown in a two-step process. In the first step, seeds or droplets of a second precursor (e.g., a metal or metal oxide) are deposited on the substrate. In a second step, a chemical vapor of the first precursor (e.g., a chalcogen) saturates the seeds causing molecules of the TMD to precipitate out to form the nanoribbon 102. In some aspects, a method may comprise subjecting the two or more precursor powders to an inert gas flow at an elevated temperature sufficient to deposit monolayers of a TMD material on a substrate via chemical vapor deposition. Example inert gasses useful according to the present disclosure include, but are not limited to, argon gas (Ar) and nitrogen gas (N). According to some aspects, the inert gas may be moisturized by flowing the inert gas through a bubbler containing deionized water.

According to some aspects, each of the two or more precursor powders may be subjected to the inert gas flow simultaneously or about simultaneously. Alternatively, at least a first portion of the two or more precursor powders may be subjected to the inert gas flow upstream of at least a second portion of the two or more precursor powders to provide a vapor atmosphere of the first portion of the two or more precursor powders. As used here, the term “upstream” refers to a position closer to the source of the flow, such as the inert gas flow, in relation to a reference position. It should be understood that in some aspects, providing a first portion of the two or more precursor powders upstream of a second portion of the two or more precursor powders may provide an atmosphere at least partially surrounding the second portion of the two or more precursor powders, wherein the atmosphere comprises vapors of the first portion of the two or more precursor powders.

According to some aspects, in the example wherein the first portion of the precursor mixtures comprises at least the chalcogen powder (S or Se), while the second portion of the precursor powder mixtures comprises at least the metal oxide powder and the metal powder (Ni or Mg) as described herein, the precursor powder mixture may have a ratio of precursor powders sufficient to provide single and/or double layer ribbons of a TMD material as described herein.

The method may comprise heating the first portion of two or more precursor powders to provide chalcogen vapor atmosphere and heating the second portion of two or more precursor powders in the presence of the chalcogen vapor atmosphere to an elevated temperature sufficient to deposit single and/or double layer ribbons of a TMD material on a substrate via chemical vapor deposition. For example, as described herein, the first portion of the two or more precursor powders may comprise a chalcogen powder, and the second portion of the two or more precursor powders may comprise a precursor powder mixture comprising the metal oxide powder, the metal powder, and the salt powder as described herein. The method may comprise heating the first portion of the precursor powders to the elevated temperature to vaporize the chalcogen powder to provide the chalcogen vapor atmosphere, and heating the second portion of the precursor powder mixture in the presence of the chalcogen vapor atmosphere as described herein to the elevated temperature sufficient to vaporize the second portion of the precursor powder mixture. In this way, single and/or double layer ribbons of a TMD material may be deposited on a substrate provided proximal to the second portion of the precursor powder mixture, for example, face-down above the second portion of the precursor powder mixture at a height between 1 mm to 3 mm. According to some aspects, the elevated temperature for the first portion of the precursor may be between about 100° C. and 700° C., optionally between about 170° C. and 600° C., and optionally between about 200° C. to 450° C.; while the elevated temperature for the second portion of the precursor may be between about 600° C. and 1000° C., optionally between about 700° C. and 900° C., and optionally between about 720° C. and 850° C.

According to some aspects, the growth of SL TMD nanoribbons may involve a two-step method. The first step comprises heating only the second portion of the precursor powder mixture to the elevated temperature under moisturized inert gas flow. The heating allows deposition of seed nanoparticles on the growth substrate placed proximal to the second portion of the precursor powder mixture, for example, face-down above the second portion of the precursor powder mixture at a height between 1 mm to 3 mm. The second portion of the precursor powders may comprise a precursor powder mixture comprising the metal oxide powder, the metal powder, and the salt powder as described herein. The deposited seed nanoparticles are compounds that may comprise a first metal (Mo or W), a second metal (Ni or Mg), an alkali metal (Na, K, Rb, or Cs), and oxygen. The elevated temperature for the second portion of the precursor may be between about 600° C. and 1000° C., optionally between about 700° C. and 900° C., and optionally between about 720° C. and 850° C. In the first step, only the second portion of the precursor powders is placed in the reaction chamber. The second step comprises heating the first portion of the precursor powders to the elevated temperature to provide a chalcogen vapor atmosphere, and heating the growth substrate with deposited seed nanoparticles, which is placed downstream of the first portion of the precursor powders, to the elevated temperature. The chalcogen vapor reacts with the seed nanoparticles deposited on the growth substrate in the first step to make the TMD nanoribbons precipitate from the seed nanoparticles. The first portion of the precursor powders may comprise a chalcogen powder. The elevated temperature for the first portion of the precursor may be between about 100° C. and 700° C., optionally between about 170° C. and 600° C., and optionally between about 200° C. to 450° C. The elevated temperature for the growth substrate may be between about 600° C. and 1000° C., optionally between about 700° C. and 900° C., and optionally between about 720° C. and 850° C. In the second step, only the first portion of the precursor powders is placed in the reaction chamber, upstream of the growth substrate with deposited seed nanoparticles. The two-step method provides for direct grown of single-crystal SL TMD nanoribbons with controllable downscaling of the nanoribbon widths to 7 nm.

While a chemical vapor deposition technique is described above for the deposition of the nanoribbon 102, other methods such as physical vapor deposition, atomic layer deposition, pulsed laser ablation, evaporation, sputtering, etc., may also be used according to aspects of the present disclosure.

Still referring to FIG. 1A, an excitation laser 110 may be applied to the nanoribbon 102. The energy in the excitation laser 110 (carried by photons) may create excitons (electron-hole pairs) in the nanoribbon 102 that cause the electrons to promote from the valence band to the conduction band. When the excitons collapse (electrons falling back to the valence band and combining with holes), an emission 112 occurs. In some implementations, a cryostat 120 cools the substrate 100 and the nanoribbon 102 to a desired operational temperature. For example, the operational temperature may be less than 120 Kelvin. In some implementations, the operational temperature is between 4 Kelvin and 120 Kelvin, between 4 Kelvin and 80 Kelvin, between 80 Kelvin and 120 Kelvin, or between 90 Kelvin and 120 Kelvin.

FIG. 1B illustrates an example of a single photon emitter according to aspects of the present disclosure. A single photon emitter 150 may include the nanoribbon 102 being placed over a nanostructure 152 (a nanocone as illustrated) on a second substrate 160. The nanoribbon 102 has a quasi-one dimensional structure allowing the nanoribbon 102 to sharply bend over the tip of the nanostructure 152. The bending of the nanoribbon 102 at the tip of the nanostructure 152 creates strain that leads to single photon emission. The excitation laser 110 may create excitons in the nanoribbon 102.

In some implementations, the excitation laser 110 has a wavelength of 532 nm. The power of the excitation laser is between 60 nW and 20 μW. The single photon emissions generated from strained nanoribbon 102 by nanostructures 152 have the single photon purity of 80%-98%, operation temperature up to 120 K, brightness of 100 kHz to 1 MHz, deterministic positioning of 1-2 emission per site.

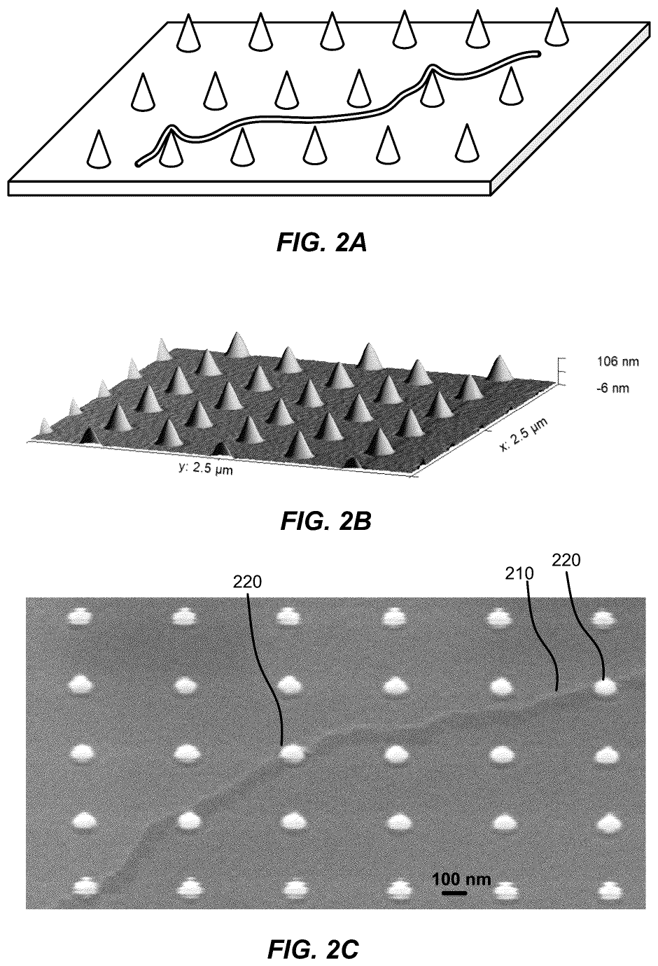

FIG. 2A illustrates an example of a schematic showing a substrate 200 having a plurality of nanocones 220 and a nanoribbon 210 according to aspects of the present disclosure. The nanoribbon 210 may be non-linear. When placed on top of the substrate 200, the nanoribbon 210 may align with one or more of the nanocones 220.

FIG. 2B illustrates an example of an atomic-force microscopy (AFM) image of the gold (Au) nanocones on a silicon dioxide (SiO₂) substrate on which the SL TMD nanoribbons 210 will be placed. The height of the nanocones is ˜100 nanometers (nm), and the size of the nanocone apex ranges from 5 to 50 nm. The nanocones 220 may be arranged with regular spacing.

FIG. 2C illustrates an example of a scanning electron microscopy (SEM) image showing a SL MoS₂ nanoribbon 210 lying on the substrate 200 with Au nanocones 220. The nanoribbon 210 lies at the apex of two nanocones 220.

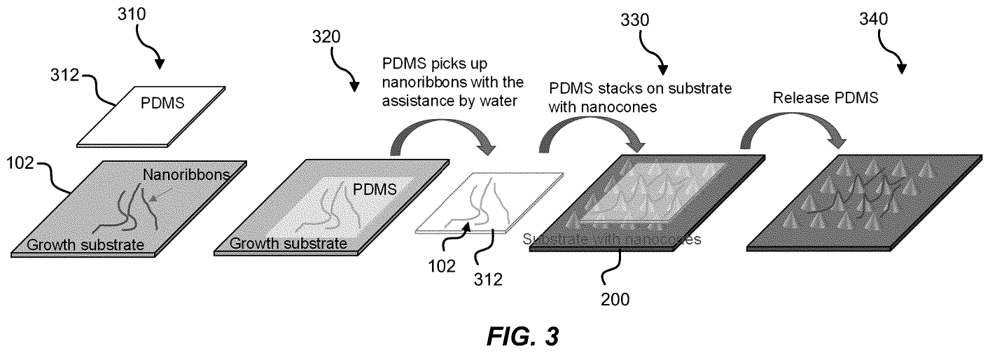

FIG. 3 illustrates an example process of placing nanoribbons on the nanostructures. As discussed above, the nanoribbons 102 are grown on a growth substrate 100. A polymer film 312 is placed on the growth substrate 100 with the as-grown nanoribbons 102. For example, the polymer film may comprise polydimethylsiloxane (PDMS). The nanoribbons 102 adhere to the polymer film. At step 320, the substrate 100, nanoribbons 102, and the polymer film 310 are floated in deionized water causing the polymer film 310 and the nanoribbons 102 to detach from the growth substrate.

At step 330, a second substrate 160 with nanostructures 152 is provided. For example, the second substrate 200 may be formed by evaporating a base layer of gold onto a silicon wafer, followed by electron-beam lithography and Al₂O₃ deposition. After lift-off, disks of alumina are left behind, which serve as a hard mask during a final argon ion milling step. The polymer film 310 carrying the nanoribbons 102 is stacked with the second substrate 200. An optical microscope can be used to align one or more nanostructures 152 with one or more nanoribbons 102. At step 340, the nanoribbons 102 can be released from the polymer film 312 by heating the stacked structure to an elevated temperature of approximately 80° C. The polymer film 312 may be peeled off, leaving the nanoribbons 102 on the second substrate 200 with the nanostructures 152.

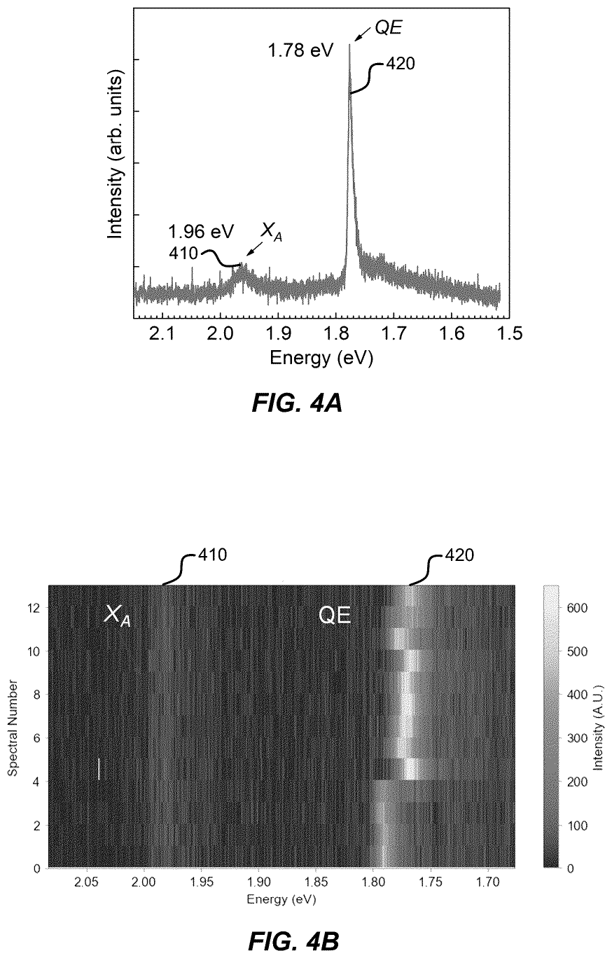

FIG. 4A illustrates an example of an emission spectrum from the spot where the SL MoS₂ nanoribbon 210 (FIG. 2C) lies across the apex of the nanocone 220 as indicated in FIG. 2C. The emission spectrum was acquired with 532 nm laser excitation at 4 K. The small band 410 at 1.96 electron volt (eV) is the typical emission from A exciton (X_{A}) in SL MoS₂. The strong sharp peak 420 at 1.78 eV is the quantum emission (QE) due to point-like strain created in the nanoribbon 210 by nanocone apex of one of the two nanocones 220 (FIG. 2C).

FIG. 4B illustrates an example of an emission intensity and energy mapping of consecutive spectral scans. The weaker emission at 1.96 eV is the A exciton emission corresponding to small band 410, whose energy and intensity barely change during the consecutive scanning. The stronger emission at ˜1.75-1.8 eV (corresponding to the sharp peak 420) is the quantum emission, whose energy and intensity shift during the consecutive scanning (called ‘spectral wandering and blinking’), which is a typical phenomenon for quantum emission.

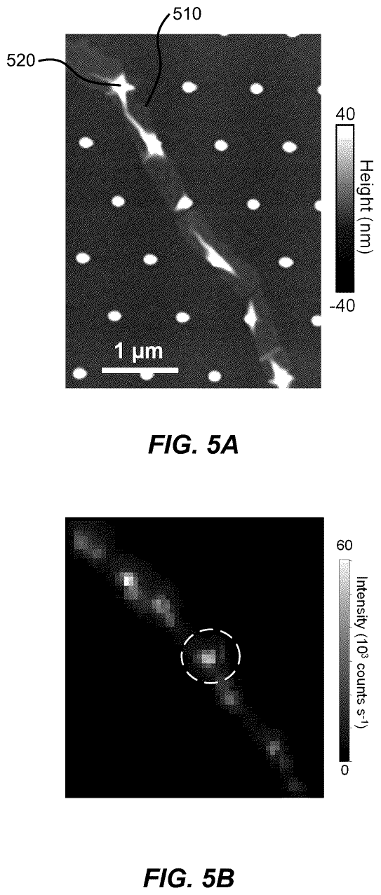

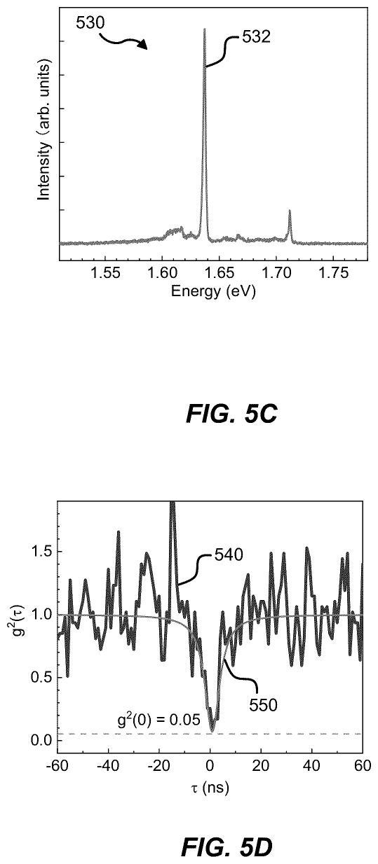

FIG. 5A illustrates an example of an AFM topography showing a strained SL WSe₂ nanoribbon 510 on Au nanocones 520. The SL WSe₂ nanoribbon 510 lies across the respective peak of several nanocones 520. At each nanocone 520, the nanoribbon 510 experiences sharp bending, causing a stress point in the nanoribbon 510.

FIG. 5B illustrates a mapping of integrated emission intensity from the strained SL WSe₂ nanoribbon 510 when excited by a 532 nm laser at 4 K. The locations corresponding to the nanocones 520 show a greater intensity.

FIG. 5C illustrates an emission spectrum 530 from one of the regions of the SL WSe₂ nanoribbon 510 strained by a nanocone 520. In particular, the chart of emission spectrum is for the point indicated by the dashed circle in FIG. 5B. The emission spectrum 530 shows a dominant quantum emission peak 532 at ˜1.64 eV from the located energy states created by the strain.

FIG. 5D illustrates a chart of a g²(τ) factor photon anti-bunching measurement on the quantum emission at ˜1.64 eV in FIG. 5C. The g²(τ) factor is an autocorrelation of measurements with a time offset t. An ideal single photon emitter would have a g²(0) factor of 0 (meaning 100% single photon purity). The dip at t=0 ns (g²(0)<1) indicates photon anti-bunching and is the proof of single photon emission (SPE). The curve 540 the measured signal, and the curve 550 the fitting curve. The peak value of g²(0)=0.05 corresponds to a 95% single photon purity.

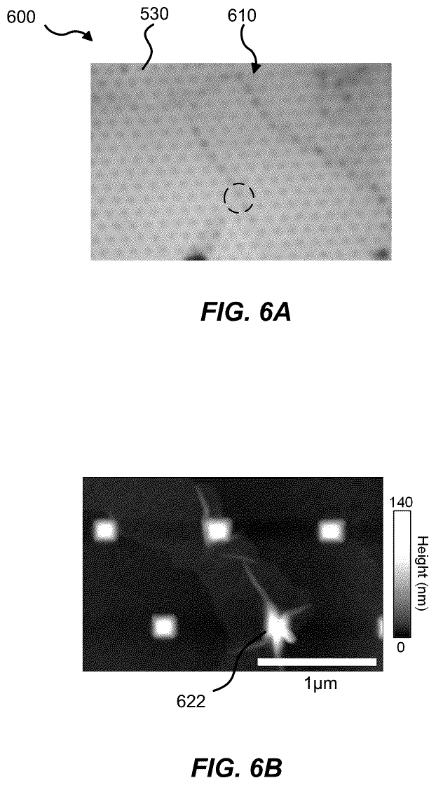

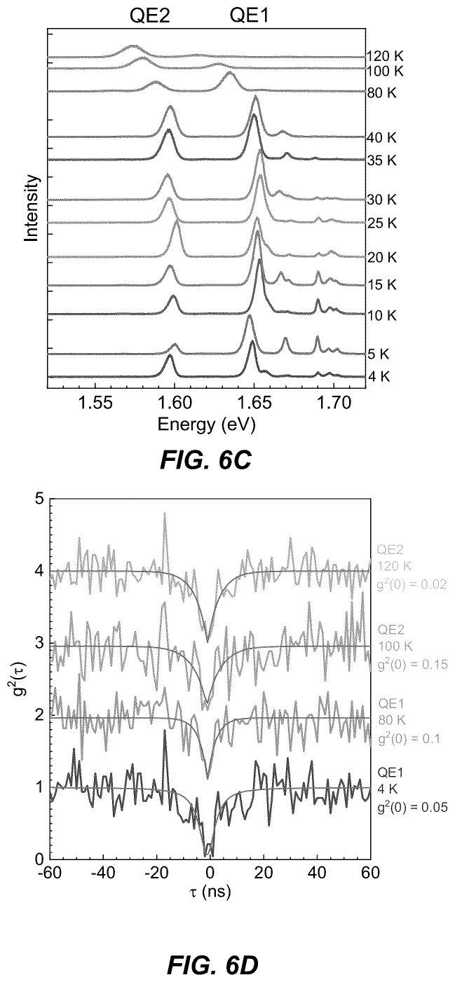

FIG. 6A is an image from an optical microscope showing an example of strained SL WSe₂ nanoribbons 610 on Au nano-pyramids 620. Similar to the examples above, a substrate 600 includes regularly spaced nanostructures, in this case, nano-pyramids. The curved path of darker spots is a nanoribbon 610.

FIG. 6B is an AFM topography showing the region indicated by the dashed circle in FIG. 6A. Similar to the nanocones, the nano-pyramids cause the nanoribbon 610 to bend sharply, creating stress in the nanoribbon 610.

FIG. 6C is a series of temperature-dependent (from 4 to 120 K) emission spectra from the region 622 of the SL WSe₂ nanoribbon 610 strained by the nano-pyramid 620 in FIG. 6B. The temperature (in Kelvin) is labeled along the right side. The emission spectrum for each temperature is offset to allow comparison of the emission spectra. Each curve shows relative changes of intensity at the respective temperature. For all temperatures, the emission spectra show two dominant quantum emission peaks at ˜1.65-1.63 eV (QE1) and ˜1.60-1.57 eV (QE2) from the located energy states created by the strain. The QE1 and QE2 generally shift to lower emission energy and broaden with increasing temperature, corresponding to the temperature-dependent behavior of the quantum emissions.

FIG. 6D is a chart of g²(τ) factor photon anti-bunching measurements on QE1 and QE2 from temperature 4 K to 120 K. Remarkably, the QE2 shows a g²(0) value of 0.02, corresponding to a single photon purity of 98% at 120 K, the highest ever reported for single photon emission from TMD materials at temperatures above 100 K. The high purity emission at relatively high temperature may have applications in many settings where temperatures near absolute zero may be impractical.

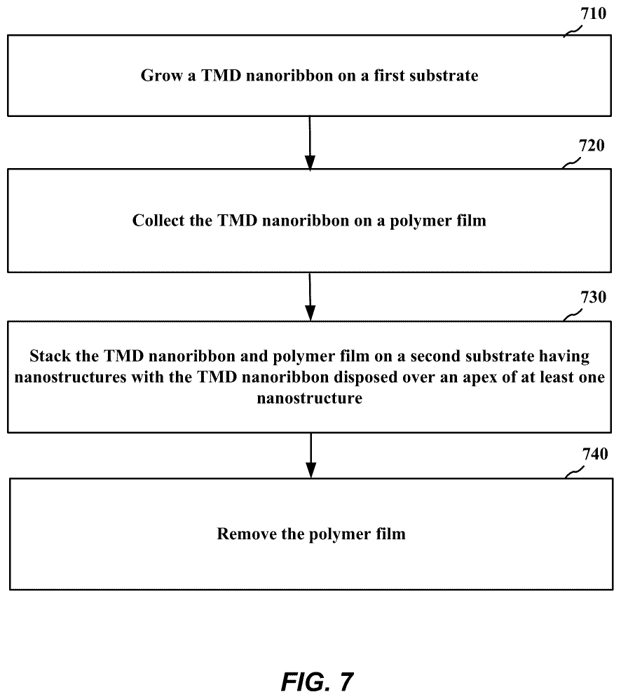

FIG. 7 is a flowchart of an example method 700 for manufacturing a single photon emitter.

At block 710, the method 700 includes growing a transition metal dichalcogenide (TMD) nanoribbon on a first substrate. For example, the block 710 may include heating a first precursor powder comprising a metal oxide powder, a metal powder, and a salt powder and passing a moisturized inert gas flow by the first precursor to deposit seed nanoparticles on the first substrate; heating a second precursor powder comprising a chalcogen upstream from the first substrate to produce a chalcogen vapor; and passing an inert gas flow from a location of the second precursor powder by the first substrate.

At block 720, the method 700 includes collecting the TMD nanoribbon on a polymer film. For example, the block 720 may include pressing the polymer film against the TMD nanoribbon on the first substrate; and floating the first substrate, TMD nanoribbon, and polymer film in deionized water.

At block 730, the method 700 includes stacking the TMD nanoribbon and polymer film on a second substrate having nanostructures with the TMD nanoribbon disposed over an apex of at least one nanostructure. For example, the block 730 may include aligning the TMD nanoribbon with the apex of the at least one nanostructure under an optical microscope.

At block 740, the method 700 includes removing the polymer film. For example, the block 740 may include heating the stacked polymer film, the TMD nanoribbon, and the second substrate.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, where reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The word “about” is used herein to mean within +5% of the stated value, optionally within +4%, optionally within +3%, optionally within +2%, optionally within +1%, optionally within +0.5%, optionally within +0.1%, and optionally within +0.01%. It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A single photon emitter, comprising:
a substrate;
at least one nanostructure disposed on the substrate; and
a nanoribbon disposed over at least one apex of the at least one nanostructure.

2. The single photon emitter of claim 1, wherein the nanoribbon comprises a transition metal dichalcogenide (TMD).

3. The single photon emitter of claim 2, wherein the TMD is one of: MoS₂, MoSe₂, WS₂, or WSe₂.

4. The single photon emitter of claim 1, wherein the nanoribbon has a width between 7 and 50 nm.

5. The single photon emitter of claim 4, wherein the nanoribbon has width between 7 and 20 nm.

6. The single photon emitter of claim 1, wherein the at least one nanostructure comprises one or more of a nanocone, a nanopillar, a nano-pyramid, or a nano-ridge.

7. The single photon emitter of claim 1, wherein a tip size of the nanostructure is between 20 and 50 nanometers.

8. The single photon emitter of claim 1, wherein the nanoribbon is a single layer.

9. The single photon emitter of claim 1, wherein the substrate is silicon dioxide and the nanostructure is gold.

10. The single photon emitter of claim 1, wherein a single photon purity of an emission is between 95 percent and 98 percent as measured by g²(τ).

11. The single photon emitter of claim 10, wherein the single photon purity is between 95 percent and 98 percent when operating at a temperature between 90 Kelvin and 120 Kelvin.

12. The single photon emitter of claim 1, further comprising an excitation laser configured to emit at beam toward the nanoribbon disposed over at least one apex of the at least one nanostructure.

13. The single photon emitter of claim 12, wherein the excitation laser has an excitation wavelength of about 532 nm and a power between 60 nW and 20 μW.

14. The single photon emitter of claim 1, further comprising a cryostat configured to cool the substrate and the nanoribbon to a temperature less than 120 Kelvin.

15. A method of manufacturing a single photon emitter, the method comprising:
growing a transition metal dichalcogenide (TMD) nanoribbon on a first substrate;
collecting the TMD nanoribbon on a polymer film;
stacking the TMD nanoribbon and polymer film on a second substrate having nanostructures with the TMD nanoribbon disposed over an apex of at least one nanostructure; and
removing the polymer film.

16. The method of claim 15, wherein growing the TMD nanoribbon comprises:
heating a first precursor powder comprising a metal oxide powder, a metal powder, and a salt powder and passing a moisturized inert gas flow by the first precursor powder to deposit seed nanoparticles on the first substrate;
heating a second precursor powder comprising a chalcogen upstream from the first substrate to produce a chalcogen vapor; and
passing an inert gas flow from a location of the second precursor powder by the first substrate.

17. The method of claim 15, wherein collecting the TMD nanoribbon on the polymer film comprises:
pressing the polymer film against the TMD nanoribbon on the first substrate; and
floating the first substrate, TMD nanoribbon, and polymer film in deionized water.

18. The method of claim 15, wherein stacking the TMD nanoribbon and polymer film on the second substrate comprises aligning the TMD nanoribbon with the apex of the at least one nanostructure under an optical microscope.

19. The method of claim 15, wherein removing the polymer film comprises heating the stacked polymer film, the TMD nanoribbon, and the second substrate.
